(19) United States
(12) Patent Application Publication
(10) Pub. No.: US 2025/0166551 A1
(43) Pub. Date: May 22, 2025

(54) DRIVER AND DISPLAY DEVICE

(71) Applicant: Samsung Display Co., Ltd., Yongin-si (KR)

(72) Inventor: SANG YONG NO, Yongin-si (KR)

(21) Appl. No.: 18/941,123

(22) Filed: Nov. 8, 2024

(30) Foreign Application Priority Data
Nov. 22, 2023 (KR) 10-2023-0163273

(51) Int. Cl. G09G 3/20

(52) U.S. Cl. CPC G09G 3/2092; G09G 2310/0286; G09G 2330/02

(57) ABSTRACT

A driver includes stages. At least one of the stages includes an input circuit that transfers an input signal to a third node in response to a clock signal, an inverter circuit that inverts a voltage of the third node and generates a voltage of a fourth node, a first node control circuit that controls a voltage of a first node based on the voltage of the fourth node and a voltage of a second node, a second node control circuit that controls the voltage of the second node based on the voltage of the third node and the voltage of the first node, and an output circuit that generates an output signal based on the voltages of the first and second nodes. At least one of the inverter circuit, the first node control circuit and the second node control circuit includes different types of transistors.

This application claims priority to Korean Patent Application No. 10-2023-0163273, filed on Nov. 22, 2023, and all the benefits accruing therefrom under 35 U.S.C. § 119, the content of which in its entirety is herein incorporated by reference.

### BACKGROUND

### 1. Field

Embodiments of the inventive concept relate to a display device, and more particularly to a driver, and a display device including the driver.

### 2. Description of the Related Art

A driver (e.g., a gate driver and/or an emission driver) of a display device may sequentially provide signals (e.g., gate signals and/or emission signals) to pixels of a display panel on a row-by-row basis. To sequentially provide the signals on the row-by-row basis, the driver may be implemented in a form of a shift register including a plurality of stages.

In general, each stage of the driver may include only a single type of transistor, e.g., a p-type metal-oxide-semiconductor (“PMOS”) transistor.

### SUMMARY

Some embodiments provide a driver in which each stage includes different types of transistors.

Some embodiments provide a display device including a driver in which each stage includes different types of transistors.

In an embodiment of the disclosure, there is provided a driver including a plurality of stages. At least one stage of the plurality of stages includes an input circuit which transfers an input signal to a third node in response to a clock signal, an inverter circuit which inverts a voltage of the third node and generates a voltage of a fourth node, a first node control circuit which controls a voltage of a first node based on the voltage of the fourth node and a voltage of a second node, a second node control circuit which controls the voltage of the second node based on the voltage of the third node and the voltage of the first node, and an output circuit which generates an output signal based on the voltage of the first node and the voltage of the second node. At least one of the inverter circuit, the first node control circuit and the second node control circuit includes different types of transistors.

In an embodiment, the output signal may have a first low gate voltage as a low voltage, the fourth node may have a second low gate voltage as a low voltage, the first node may have a third low gate voltage as a low voltage, and at least two of the first, second and third low gate voltages may have different voltage levels.

In an embodiment, the second low gate voltage may be higher than the first low gate voltage, and the third low gate voltage may be lower than or equal to the first low gate voltage.

In an embodiment, a low gate voltage of the clock signal may be different from the first, second and third low gate voltages.

In an embodiment, the input signal, the clock signal, the output signal, the first node, the second node, the third node and the fourth node may have a same high gate voltage as a high voltage.

In an embodiment, the output circuit may include a first p-type metal-oxide-semiconductor (“PMOS”) transistor which outputs a high gate voltage as the output signal in response to the voltage of the second node, and a second PMOS transistor which outputs a first low gate voltage as the output signal in response to the voltage of the first node.

In an embodiment, the input circuit may include a third PMOS transistor which transfers the input signal to the third node in response to the clock signal.

In an embodiment, the input circuit may further include a fourth n-type metal-oxide-semiconductor (“NMOS”) transistor which transfers the input signal to the third node in response to an inverted clock signal.

In an embodiment, the inverter circuit may include a fourth PMOS transistor which provides a high gate voltage to the fourth node in response to the voltage of the third node, and a first NMOS transistor which provides a second low gate voltage to the fourth node in response to the voltage of the third node.

In an embodiment, the first node control circuit may include a fifth PMOS transistor which provides a high gate voltage to the first node in response to the voltage of the fourth node, and a second NMOS transistor which provides a third low gate voltage to the first node in response to the voltage of the second node.

In an embodiment, the second node control circuit may include a sixth PMOS transistor which provides a high gate voltage to the second node in response to the voltage of the third node, and a third NMOS transistor which provides a third low gate voltage to the second node in response to the voltage of the first node.

In an embodiment, the at least one stage may further include a capacitor connected between the third node and a second low gate voltage line.

In an embodiment, the at least one stage may further include a capacitor connected between the third node and the first node.

In an embodiment, the at least one stage may further include a seventh PMOS transistor including a gate that receives a third low gate voltage, and disposed at the first node to separate the first node into a fifth node and a sixth node, and a capacitor connected between an output node at which the output signal is output and the sixth node.

In an embodiment, the first node control circuit may include a second NMOS transistor which provides a third low gate voltage to the first node, the second node control circuit may include a third NMOS transistor which provides the third low gate voltage to the second node, and each of the second and third NMOS transistors may include a bottom gate that receives a fourth low gate voltage lower than the third low gate voltage.

In an embodiment, the first node control circuit may include a second NMOS transistor which provides a third low gate voltage to the first node, and the second NMOS transistor may include a first bottom gate. The second node control circuit may include a third NMOS transistor which provides the third low gate voltage to the second node, and the third NMOS transistor may include a second bottom gate. The at least one stage may further include a first coupling capacitor connected between the second node and the first bottom gate, an eighth PMOS transistor including a gate connected to a third low gate voltage line that transfers the third low gate voltage, a first terminal connected to the first bottom gate, and a second terminal connected to the third low gate voltage line, a second coupling capacitor connected between the first node and the second bottom gate, and a ninth PMOS transistor including a gate connected to the third low gate voltage line, a first terminal connected to the second bottom gate, and a second terminal connected to the third low gate voltage line.

In an embodiment, the at least one stage may further include a carry circuit which generates a carry signal based on the voltage of the fourth node. The carry circuit may include a tenth PMOS transistor which outputs a high gate voltage as the carry signal in response to the voltage of the fourth node, and a fifth NMOS transistor which outputs a second low gate voltage as the carry signal in response to the voltage of the fourth node.

In an embodiment, the second low gate voltage may be higher than a first low gate voltage that is a low voltage of the output signal, and a low gate voltage of the clock signal may be higher than the first low gate voltage and lower than the second low gate voltage.

By embodiments, there is provided a driver including a plurality of stages. At least one stage of the plurality of stages includes a first PMOS transistor including a gate connected to a second node, a first terminal connected to a high gate voltage line, and a second terminal connected to an output node, a second PMOS transistor including a gate connected to a first node, a first terminal connected to the output node, and a second terminal connected to a first low gate voltage line, a third PMOS transistor including a gate that receives a clock signal, a first terminal that receives an input signal, and a second terminal connected to a third node, a fourth PMOS transistor including a gate connected to the third node, a first terminal connected to the high gate voltage line, and a second terminal connected to a fourth node, a first NMOS transistor including a gate connected to the third node, a first terminal connected to the fourth node, and a second terminal connected to a second low gate voltage line, a fifth PMOS transistor including a gate connected to the fourth node, a first terminal connected to the high gate voltage line, and a second terminal connected to the first node, a second NMOS transistor including a gate connected to the second node, a first terminal connected to the first node, and a second terminal connected to a third low gate voltage line, a sixth PMOS transistor including a gate connected to the third node, a first terminal connected to the high gate voltage line, and a second terminal connected to the second node, a third NMOS transistor including a gate connected to the first node, a first terminal connected to the second node, and a second terminal connected to the third low gate voltage line, and a capacitor connected between the third node and the second low gate voltage line.

In an embodiment of the disclosure, there is provided a display device including a display panel including a plurality of pixels, a data driver which provides data signals to the plurality of pixels, a gate driver which provides gate signals to the plurality of pixels, an emission driver which provides emission signals to the plurality of pixels, and a controller which controls the data driver, the gate driver and the emission driver. At least one of the gate driver and the emission driver includes a plurality of stages. At least one stage of the plurality of stages includes an input circuit which transfers an input signal to a third node in response to a clock signal, an inverter circuit which inverts a voltage of the third node and generates a voltage of a fourth node, a first node control circuit which controls a voltage of a first node based on the voltage of the fourth node and a voltage of a second node, a second node control circuit which controls the voltage of the second node based on the voltage of the third node and the voltage of the first node, and an output circuit which generates an output signal based on the voltage of the first node and the voltage of the second node. At least one of the inverter circuit, the first node control circuit and the second node control circuit includes different types of transistors.

As described above, in a driver and a display device in embodiments, at least one stage may include an input circuit, an inverter circuit, a first node control circuit, a second node control circuit and an output circuit, and at least one of the inverter circuit, the first node control circuit and the second node control circuit may include different types of transistors. Further, a swing width of a clock signal applied to the input circuit may be smaller than a swing width of an output signal output from the output circuit. Accordingly, the driver may stably operate while reducing power consumption.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating an embodiment of a driver.

FIG. 2 is a timing diagram for describing an operation of a driver of FIG. 1.

FIG. 3 is a block diagram illustrating an embodiment of a stage of a driver.

FIG. 4 is a diagram for describing an embodiment of voltages for a driver.

FIG. 5 is a circuit diagram illustrating an embodiment of a stage of a driver.

FIG. 6 is a timing diagram for describing an embodiment of an operation of a stage of FIG. 5.

FIG. 7 is a circuit diagram for describing an embodiment of an operation of a stage of FIG. 5 in a first time period.

FIG. 8 is a circuit diagram for describing an embodiment of an operation of a stage of FIG. 5 in a second time period.

FIG. 9 is a circuit diagram illustrating an embodiment of a stage of a driver.

FIG. 10 is a timing diagram for describing an embodiment of an operation of a stage of FIG. 9.

FIG. 11 is a circuit diagram illustrating an embodiment of a stage of a driver.

FIG. 12 is a circuit diagram illustrating an embodiment of a stage of a driver.

FIG. 13 is a circuit diagram illustrating an embodiment of a stage of a driver.

FIG. 14 is a block diagram illustrating an embodiment of a driver.

FIG. 15 is a circuit diagram illustrating an embodiment of a stage of a driver.

FIG. 16 is a diagram for describing an embodiment of voltages for a driver.

FIG. 17 is a block diagram illustrating an embodiment of a display device.

FIG. 18 is a block diagram illustrating an embodiment of an electronic device including a display device.

### DETAILED DESCRIPTION

The embodiments are described more fully hereinafter with reference to the accompanying drawings. Like or similar reference numerals refer to like or similar elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” can mean within one or more standard deviations, or within +30%, 20%, 10%, 5% of the stated value, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

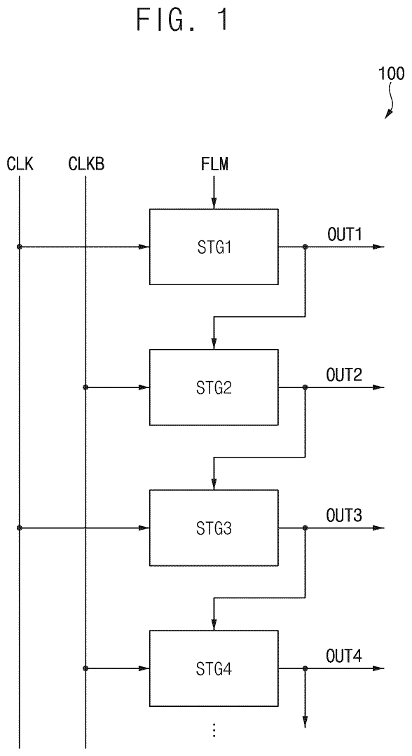

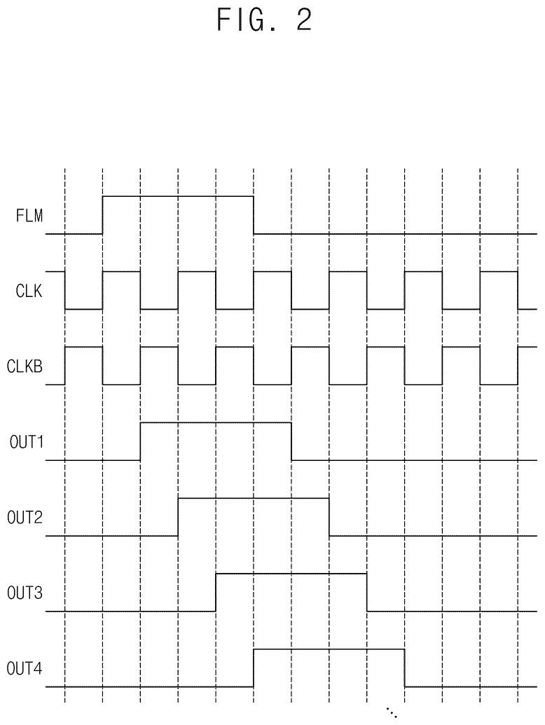

FIG. 1 is a block diagram illustrating an embodiment of a driver, and FIG. 2 is a timing diagram for describing an operation of a driver of FIG. 1.

Referring to FIG. 1, a driver 100 in embodiments may include a plurality of stages STG1, STG2, STG3, STG4, etc. The driver 100 may be implemented in the form of a shift register in which a plurality of stages STG1, STG2, STG3, STG4, etc., sequentially output output signals OUT1, OUT2, OUT3, OUT4, etc. In some embodiments, the driver 100 may be included in a display device, and may be formed in a display panel of the display device. In an embodiment, the driver 100 may be integrated or formed in/on a substrate of the display panel, for example.

The plurality of stages STG1, STG2, STG3, STG4, etc., may sequentially output the output signals OUT1, OUT2, OUT3, OUT4, etc., based on a start signal FLM, a clock signal CLK and an inverted clock signal CLKB. Further, a first stage STG1 may receive the start signal FLM as an input signal, and each of subsequent stages STG2, STG3, STG4, etc., may receive the output signal of a previous stage as the input signal. In an embodiment, a second stage STG2 may receive a first output signal OUT1 of the first stage STG1 as the input signal, a third stage STG3 may receive a second output signal OUT2 of the second stage STG2 as the input signal, and a fourth stage STG4 may receive a third output signal OUT3 of the third stage STG3 as the input signal, for example.

In some embodiments, each odd-numbered stage STG1, STG3, etc., may start outputting the output signal OUT1, OUT3, etc., when the clock signal CLK has a relatively low level (e.g., logic low level), and each even-numbered stage STG2, STG4, etc., may start outputting the output signal OUT2, OUT4, etc., when the inverted clock signal CLKB has the relatively low level. In an embodiment, as illustrated in FIGS. 1 and 2, when the clock signal CLK becomes the relatively low level after the start signal FLM becomes a relatively high level (e.g., logic high level), the first stage STG1 may start outputting the first output signal OUT1 having the relatively high level, for example. Further, when the clock signal CLK becomes the relatively low level after the start signal FLM becomes the relatively low level, the first stage STG1 may start outputting the first output signal OUT1 having the relatively low level. When the inverted clock signal CLKB becomes the relatively low level after the first output signal OUT1 becomes the relatively high level, the second stage STG2 may start outputting the second output signal OUT2 having the relatively high level. Further, when the inverted clock signal CLKB becomes the relatively low level after the first output signal OUT1 becomes the relatively low level, the second stage STG2 may start outputting the second output signal OUT2 having the relatively low level. When the clock signal CLK becomes the relatively low level after the second output signal OUT2 becomes the relatively high level, the third stage STG3 may start outputting the third output signal OUT3 having the relatively high level. Further, when the clock signal CLK becomes the relatively low level after the second output signal OUT2 becomes the relatively low level, the third stage STG3 may start outputting the third output signal OUT3 having the relatively low level. When the inverted clock signal CLKB becomes the relatively low level after the third output signal OUT3 becomes the relatively high level, the fourth stage STG4 may start outputting the fourth output signal OUT4 having the relatively high level. Further, when the inverted clock signal CLKB becomes the relatively low level after the third output signal OUT3 becomes the relatively low level, the fourth stage STG4 may start outputting the fourth output signal OUT4 having the relatively low level. In this manner, the plurality of stages STG1, STG2, STG3, STG4, etc., may sequentially output the output signals OUT1, OUT2, OUT3, OUT4, etc., by delaying or shifting the output signals OUT1, OUT2, OUT3, OUT4, etc., by half a period of the clock signal CLK.

Although FIG. 2 illustrates an example where each of the clock signal CLK and the inverted clock signal CLKB has a clock duty of about 50%, the clock signal CLK and the inverted clock signal CLKB provided to the driver 100 according to the disclosure are not limited to the embodiment of FIG. 2. In an embodiment, to ensure that a low period of the clock signal CLK and a low period of the inverted clock signal CLKB do not overlap each other, each of the clock signal CLK and the inverted clock signal CLKB may have a low period that is shorter than a high period, and the low period of the clock signal CLK and the low period of the inverted clock signal CLKB may have a substantially constant time interval, for example.

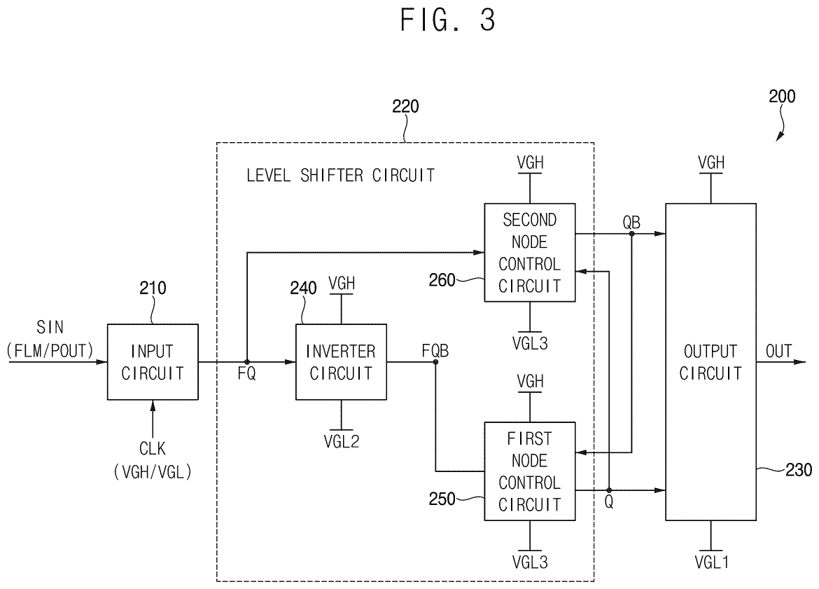

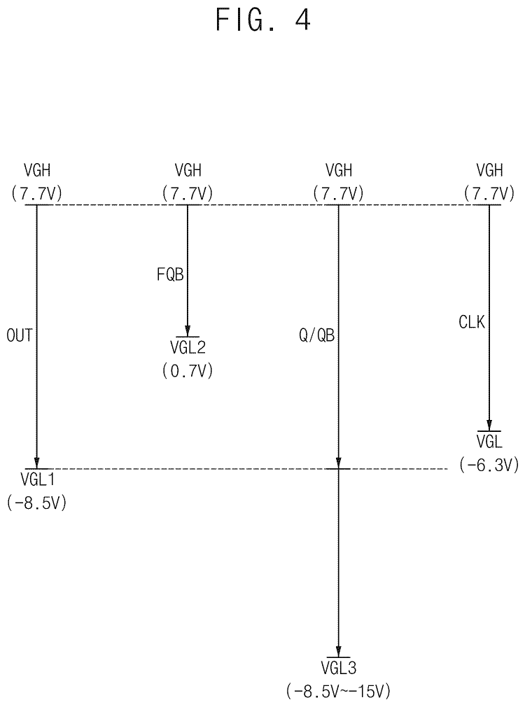

FIG. 3 is a block diagram illustrating an embodiment of a stage of a driver, and FIG. 4 is a diagram for describing an embodiment of voltages for a driver.

Referring to FIG. 3, each stage 200 of a driver in embodiments may include an input circuit 210 that receives an input signal SIN, a level shifter circuit 220 that performs a level shifting operation such that a first node Q and/or a second node QB have a voltage (e.g., a third low gate voltage VGL3) that is different from a voltage (e.g., a first low gate voltage VGL1) of the input signal SIN, and an output circuit 230 that generates an output signal OUT based on voltages of the first and second nodes Q and QB. In some embodiments, the level shifter circuit 220 may include an inverter circuit 240, a first node control circuit 250 and a second node control circuit 260.

The input circuit 210 may transfer the input signal SIN to a third node FQ in response to a clock signal CLK. In some embodiments, as illustrated in FIGS. 1 and 2, the input circuit 210 of a first stage of the driver may receive a start signal FLM as the input signal SIN, and each of subsequent stages may receive an output signal POUT of a previous stage as the input signal SIN. Further, in some embodiments, as illustrated in FIGS. 1 and 2, the input circuit 210 of an odd-numbered stage may transfer the input signal SIN to its third node FQ in response to the clock signal CLK, and the input circuit 210 of an even-numbered stage may transfer the input signal SIN to its third node FQ in response to an inverted clock signal CLKB.

In some embodiments, the input signal SIN and the clock signal CLK have substantially the same high gate voltage VGH as a high voltage, but a low gate voltage VGL that is a low voltage of the clock signal CLK may be higher than a first low gate voltage VGL1 that is a low voltage of the input signal SIN (e.g., the output signal POUT of the previous stage). Further, as illustrated in FIG. 4, the output signal OUT and the clock signal CLK have substantially the same high gate voltage VGH as a high voltage, but the low gate voltage VGL of the clock signal CLK may be higher than the first low gate voltage VGL1 of the output signal OUT. In an embodiment, the high gate voltage VGH may be, but is not limited to, about 7.7 volts (V), the first low gate voltage VGL1 may be, but is not limited to, about −8.5V, and the low gate voltage VGL of the clock signal CLK may be, but is not limited to, about −6.3V, for example. That is, the clock signal CLK may have a swing width of the high gate voltage VGH to the low gate voltage VGL, which is smaller than a swing width of the output signal OUT from the high gate voltage VGH to the first low gate voltage VGL1. Accordingly, since the clock signal CLK has a relatively small swing width, power consumption of the driver in embodiments may be reduced.

The inverter circuit 240 may invert a voltage of the third node FQ to generate a voltage of a fourth node FQB. In an embodiment, the inverter circuit 240 may cause the voltage of the fourth node FQB to have a relatively low level when the voltage of the third node FQ has a relatively high level, and may cause the voltage of the fourth node FQB to have a relatively high level when the voltage of the third node FQ has a relatively low level, for example. In some embodiments, the inverter circuit 240 may receive the high gate voltage VGH and a second low gate voltage VGL2, and may control the voltage of the fourth node FQB based on the high gate voltage VGH and the second low gate voltage VGL2. Accordingly, as illustrated in FIG. 4, the fourth node FQB may have the high gate voltage VGH as a high voltage and the second low gate voltage VGL2 as a low voltage. In some embodiments, the second low gate voltage VGL2 may be higher than the first low gate voltage VGL1. In an embodiment, the first low gate voltage VGL1 may be, but is not limited to, about −8.5V, and the second low gate voltage VGL2 may be, but is not limited to, about 0.7V, for example.

The first node control circuit 250 may control the voltage of the first node Q based on the voltage of the fourth node FQB and the voltage of the second node QB, and the second node control circuit 260 may control the voltage of the second node QB based on the voltage of the third node FQ and the voltage of the first node Q. In some embodiments, the first and second node control circuits 250 and 260 may receive the high gate voltage VGH and the third low gate voltage VGL3, and may control the voltages of the first and second nodes Q and QB based on the high gate voltage VGH and the third low gate voltage VGL3. Thus, as illustrated in FIG. 4, the first node Q and/or the second node QB may have the high gate voltage VGH as a high voltage and the third low gate voltage VGL3 as a low voltage. In some embodiments, the third low gate voltage VGL3 may be lower than or equal to the first low gate voltage VGL1. In an embodiment, the first low gate voltage VGL1 may be, but is not limited to, about −8.5V, and the third low gate voltage VGL3 may be, but is not limited to, about −8.5V to about −15V, for example.

The output circuit 230 may generate the output signal OUT based on the voltage of the first node Q and the voltage of the second node QB. In some embodiments, the output circuit 230 may receive the high gate voltage VGH and the first low gate voltage VGL1, and may generate the output signal OUT having the high gate voltage VGH as a high voltage and the first low gate voltage VGL1 as a low voltage. Further, since the first node Q and/or the second node QB have, as a low voltage, the third low gate voltage VGL3 lower than the first low gate voltage VGL1 of the output signal OUT, and the output circuit 230 operates based on the third low gate voltage VGL3 of the first node Q and/or the second node QB, the output circuit 230 may stably operate without performing a bootstrapping operation that decreases the low voltage of the first node Q and/or the second node QB. Further, even when a threshold voltage of a transistor included in the stage 200 is shifted, the stage 200 may stably operate based on the third low gate voltage VGL3 lower than the first low gate voltage VGL1.

In the stage 200 in embodiments, at least one of the inverter circuit 240, the first node control circuit 250 and the second node control circuit 260 may include different types of transistors. That is, at least one of the inverter circuit 240, the first node control circuit 250 and the second node control circuit 260 may include both of a p-type transistor (e.g., a p-type metal-oxide-semiconductor (“PMOS”) transistor) and an n-type transistor (e.g., an n-type metal-oxide-semiconductor (“NMOS”) transistor). In some embodiments, an active region of the PMOS transistor and an active region of the NMOS transistor may include different materials from each other. In an embodiment, the active region of the PMOS transistor may include or consist of polycrystalline silicon, e.g., low temperature polycrystalline silicon (“LTPS”), but is not limited thereto. Further, the active region of the NMOS transistor may include or consist of an oxide semiconductor, an organic semiconductor, or amorphous silicon, but is not limited thereto. Further, in some embodiments, the active region of the PMOS transistor and the active region of the NMOS transistor may be formed in different layers disposed at different heights from a substrate of a display panel, but are not limited thereto.

Further, in the stage 200 in embodiments, as illustrated in FIGS. 3 and 4, the input signal SIN, the clock signal CLK, the output signal OUT, the first node Q, the second node QB, the third node FQ and the fourth node FQB may have substantially the same high gate voltage VGH as a high voltage. However, the second low gate voltage VGL2 of the fourth node FQB may be higher than the first low gate voltage VGL1 of the output signal OUT, and the third low gate voltage VGL3 of the first and second nodes Q and QB may be lower than or equal to the first low gate voltage VGL1. Further, as illustrated in FIG. 4, the clock signal CLK provided to the stage 200 may have, as a low voltage, the low gate voltage VGL that is different from the first, second and third low gate voltages VGL1, VGL2 and VGL3. In some embodiments, as described above, the low gate voltage VGL of the clock signal CLK may be higher than the first low gate voltage VGL1 of the output signal OUT, and the swing width of the clock signal CLK may be smaller than the swing width of the output signal OUT. Accordingly, the driver including the stage 200 in embodiments may stably operate while reducing power consumption.

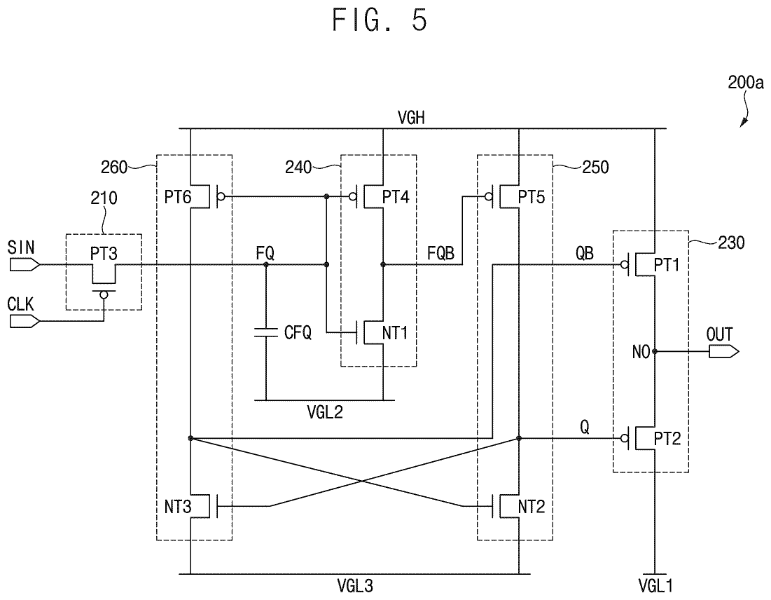

FIG. 5 is a circuit diagram illustrating an embodiment of a stage of a driver.

Referring to FIG. 5, a stage 200a of a driver in embodiments may include an input circuit 210, an output circuit 230, an inverter circuit 240, a first node control circuit 250, a second node control circuit 260 and a capacitor CFQ.

The output circuit 230 may generate an output signal OUT based on a voltage of a first node Q and a voltage of a second node QB. In some embodiments, the output circuit 230 may include a first PMOS transistor PT1 that outputs a high gate voltage VGH as the output signal OUT in response to the voltage of the second node QB, and a second PMOS transistor PT2 that outputs a first low gate voltage VGL1 as the output signal OUT in response to the voltage of the first node Q. In an embodiment, the first PMOS transistor PT1 may include a gate connected to the second node QB, a first terminal connected to a high gate voltage line that transfers the high gate voltage VGH, and a second terminal connected to an output node NO at which the output signal OUT is output, and the second PMOS transistor PT2 may include a gate connected to the first node Q, a first terminal connected to the output node NO, and a second terminal connected to a first low gate voltage line that transfers the first low gate voltage VGL1, for example.

The input circuit 210 may transfer the input signal SIN to a third node FQ in response to a clock signal CLK. In some embodiments, the input circuit 210 may include a third PMOS transistor PT3 that transfers the input signal SIN to the third node FQ in response to the clock signal CLK. In an embodiment, the third PMOS transistor PT3 may include a gate that receives the clock signal CLK, a first terminal that receives the input signal SIN, and a second terminal connected to the third node FQ, for example.

The capacitor CFQ may maintain a voltage of the third node FQ while the third PMOS transistor PT3 is turned off. In some embodiments, the capacitor CFQ may be connected between the third node FQ and a second low gate voltage line that transfers a second low gate voltage VGL2. In an embodiment, the capacitor CFQ may include a first electrode connected to the third node FQ, and a second electrode connected to the second low gate voltage line, for example.

The inverter circuit 240 may invert the voltage of the third node FQ to generate a voltage of a fourth node FQB. In some embodiments, the inverter circuit 240 may include a fourth PMOS transistor PT4 that provides the high gate voltage VGH to the fourth node FQB in response to the voltage of the third node FQ, and a first NMOS transistor NT1 that provides the second low gate voltage VGL2 to the fourth node FQB in response to the voltage of the third node FQ. In an embodiment, the fourth PMOS transistor PT4 may include a gate connected to the third node FQ, a first terminal connected to the high gate voltage line, and a second terminal connected to the fourth node FQB, and the first NMOS transistor NT1 may include a gate connected to the third node FQ, a first terminal connected to the fourth node FQB, and a second terminal connected to the second low gate voltage line, for example.

The first node control circuit 250 may control the voltage of the first node Q based on the voltage of the fourth node FQB and the voltage of the second node QB. In some embodiments, the first node control circuit 250 may include a fifth PMOS transistor PT5 that provides the high gate voltage VGH to the first node Q in response to the voltage of the fourth node FQB, and a second NMOS transistor NT2 that provides a third low gate voltage VGL3 to the first node Q in response to the voltage of the second node QB. In an embodiment, the fifth PMOS transistor PT5 may include a gate connected to the fourth node FQB, a first terminal connected to the high gate voltage line, and a second terminal connected to the first node Q, and the second NMOS transistor NT2 may include a gate connected to the second node QB, a first terminal connected to the first node Q, and a second terminal connected to a third low gate voltage line that transfers the third low gate voltage VGL3, for example.

The second node control circuit 260 may control the voltage of the second node QB based on the voltage of the third node FQ and the voltage of the first node Q. In some embodiments, the second node control circuit 260 may include a sixth PMOS transistor PT6 that provides the high gate voltage VGH to the second node QB in response to the voltage of the third node FQ, and a third NMOS transistor NT3 that provides the third low gate voltage VGL3 to the second node QB in response to the voltage of the first node Q. In an embodiment, the sixth PMOS transistor PT6 may include a gate connected to the third node FQ, a first terminal connected to the high gate voltage line, and a second terminal connected to the second node QB, and the third NMOS transistor NT3 may include a gate connected to the first node Q, a first terminal connected to the second node QB, and a second terminal connected to the third low gate voltage line, for example.

Hereinafter, an embodiment of an operation of the stage 200a is described with reference to FIGS. 5 through 8.

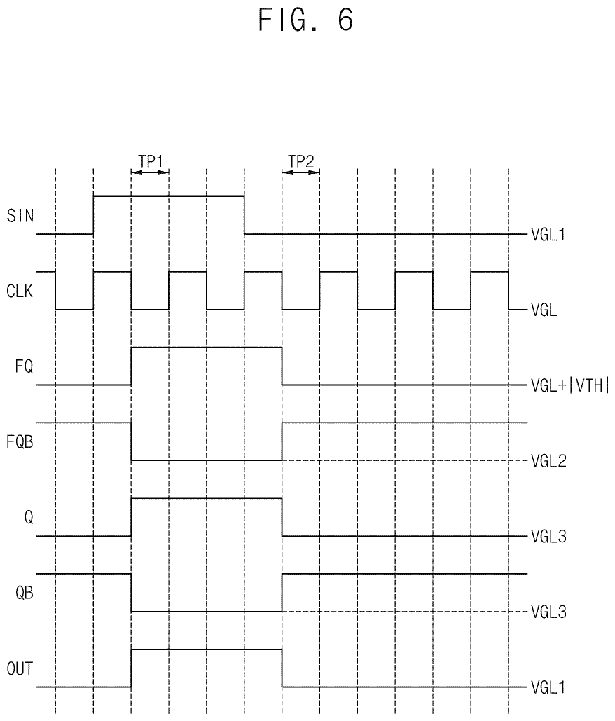

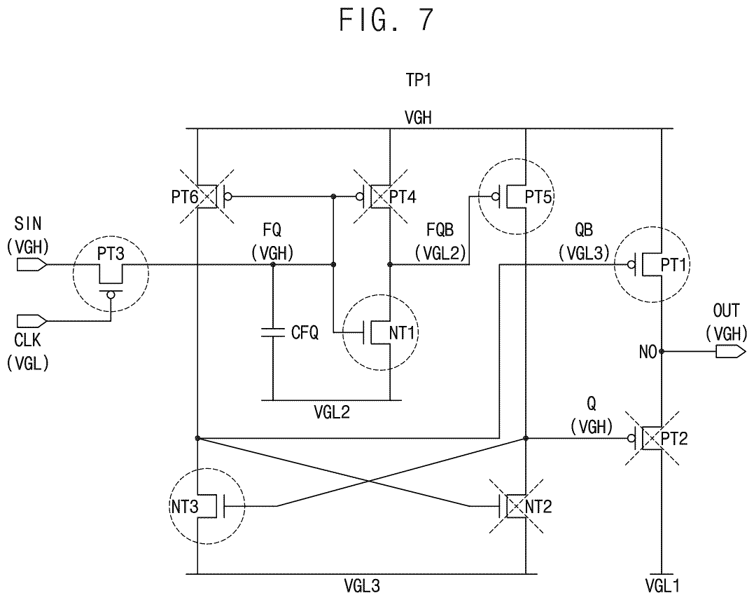

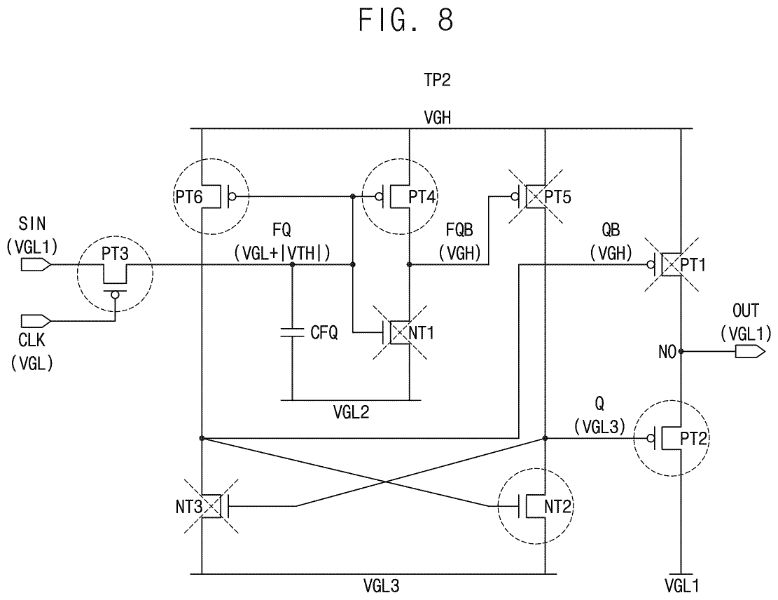

FIG. 6 is a timing diagram for describing an embodiment of an operation of a stage of FIG. 5, FIG. 7 is a circuit diagram for describing an embodiment of an operation of a stage of FIG. 5 in a first time period, and FIG. 8 is a circuit diagram for describing an embodiment of an operation of a stage of FIG. 5 in a second time period.

Referring to FIGS. 5 and 6, the stage 200a may start outputting the output signal OUT having the high gate voltage VGH (refer to FIG. 4) when the clock signal CLK becomes the low gate voltage VGL after the input signal SIN has the high gate voltage VGH, and may start outputting the output signal OUT having the first low gate voltage VGL1 when the clock signal CLK becomes the low gate voltage VGL after the input signal SIN has the first low gate voltage VGL1.

In a first time period TP1 in which the input signal SIN has the high gate voltage VGH and the clock signal CLK has the low gate voltage VGL, the stage 200a may output the output signal OUT having the high gate voltage VGH. To perform this operation, as illustrated in FIG. 7, the third PMOS transistor PT3 may be turned on in response to the clock signal CLK having the low gate voltage VGL, and may transfer the input signal SIN having the high gate voltage VGH to the third node FQ. Thus, the third node FQ may have the high gate voltage VGH.

The first NMOS transistor NT1 may be turned on in response to the high gate voltage VGH of the third node FQ, and may provide the second low gate voltage VGL2 to the fourth node FQB. The fifth PMOS transistor PT5 may be turned on in response to the second low gate voltage VGL2 of the fourth node FQB, and may provide the high gate voltage VGH to the first node Q. In some embodiments, the second low gate voltage VGL2 may be lower than a voltage obtained by subtracting a threshold voltage absolute value of the first NMOS transistor NT1 from the high gate voltage VGH to ensure that the first NMOS transistor NT1 is turned on, and may be lower than a voltage obtained by subtracting a threshold voltage absolute value of the fifth PMOS transistor PT5 from the high gate voltage VGH to ensure that the fifth PMOS transistor PT5 is turned on. That is, the second low gate voltage VGL2 may be higher than the first low gate voltage VGL1, but may be lower by the threshold voltage absolute value of the first NMOS transistor NT1 or the fifth PMOS transistor PT5 than the high gate voltage VGH.

The third NMOS transistor NT3 may be turned on in response to the high gate voltage VGH of the first node Q, and may provide the third low gate voltage VGL3 to the second node QB. Further, the fourth and sixth PMOS transistors PT4 and PT6 may be turned off in response to the high gate voltage VGH of the third node FQ, and the second NMOS transistor NT2 may be turned off in response to the third low gate voltage VGL3 of the second node QB.

The first PMOS transistor PT1 may be turned on in response to the third low gate voltage VGL3 of the second node QB, and the second PMOS transistor PT2 may be turned off in response to the high gate voltage VGH of the first node Q. Thus, the first PMOS transistor PT1 may provide the high gate voltage VGH to the output node NO, and the stage 200a may output the output signal OUT having the high gate voltage VGH at the output node NO.

Further, in a second time period TP2 in which the input signal SIN has the first low gate voltage VGL1 and the clock signal CLK has the low gate voltage VGL, the stage 200a may output the output signal OUT having the first low gate voltage VGL1. To perform this operation, as illustrated in FIG. 8, the third PMOS transistor PT3 may be turned on in response to the clock signal CLK having the low gate voltage VGL, and may transfer the input signal SIN having the first low gate voltage VGL1 to the third node FQ. In some embodiments, to reduce power consumption, the low gate voltage VGL of the clock signal CLK may be higher than the first low gate voltage VGL1 of the input signal SIN. In this case, the third node FQ may not be lowered to the first low gate voltage VGL1, and the voltage of the third node FQ may be higher than each of the low gate voltage VGL and the first low gate voltage VGL1. That is, the third PMOS transistor PT3 may be turned on until the voltage of the third node FQ becomes a sum VGL+|VTH| of the low gate voltage VGL of the clock signal CLK and a threshold voltage absolute value |VTH of the third PMOS transistor PT3. Thus, the voltage of the third node FQ may become the sum VGL+|VTH| of the low gate voltage VGL and the threshold voltage absolute value |VTH|.

The fourth and sixth PMOS transistors PT4 and PT6 may be turned on in response to the voltage VGL+|VTH| of the third node FQ. In order to ensure that the fourth and sixth PMOS transistors PT4 and PT6 are turned on, the voltage VGL+|VTH| of the third node FQ should be lower by a threshold voltage absolute value |VTH| of each of the fourth and sixth PMOS transistors PT4 and PT6 than the high gate voltage VGH. Thus, in some embodiments, the low gate voltage VGL of the clock signal CLK may be higher than the first low gate voltage VGL1 to reduce the power consumption, but may be lower than a voltage (i.e., “VGH-2×|VTH|”) obtained by subtracting twice the threshold voltage absolute value |VTH| from the high gate voltage VGH to ensure that the fourth and sixth PMOS transistors PT4 and PT6 are turned on. The fourth PMOS transistor PT4 may provide the high gate voltage VGH to the fourth node FQB, and the sixth PMOS transistor PT6 may provide the high gate voltage VGH to the second node QB.

The first NMOS transistor NT1 may be turned off in response to the voltage VGL+|VTH| of the third node FQ. To reduce a leakage current through the first NMOS transistor NT1, the second low gate voltage VGL2 at the second terminal (or a source) of the first NMOS transistor NT1 may be higher than or equal to the voltage VGL+|VTH| of the third node FQ. Thus, in some embodiments, the second low gate voltage VGL2 may be not only higher than the first low gate voltage VGL1, but also higher than or equal to the sum VGL+| VTH| of the low gate voltage VGL and the threshold voltage absolute value |VTH|. Further, the fifth PMOS transistor PT5 may be turned off in response to the high gate voltage VGH of the fourth node FQB.

The second NMOS transistor NT2 may be turned on in response to the high gate voltage VGH of the second node QB, and may provide the third low gate voltage VGL3 to the first node Q. Further, the third NMOS transistor NT3 may be turned off in response to the third low gate voltage VGL3 of the first node Q.

The first PMOS transistor PT1 may be turned off in response to the high gate voltage VGH of the second node QB, and the second PMOS transistor PT2 may be turned on in response to the third low gate voltage VGL3 of the first node Q. In some embodiments, the third low gate voltage VGL3 may be lower than or equal to the first low gate voltage VGL1. Thus, even when a bootstrapping operation that decreases the voltage of the first node Q is not performed, the second PMOS transistor PT2 may be (e.g., fully) turned on. Accordingly, the second PMOS transistor PT2 may provide the first low gate voltage VGL1 to the output node NO, and the stage 200a may output the output signal OUT having the first low gate voltage VGL1 at the output node NO.

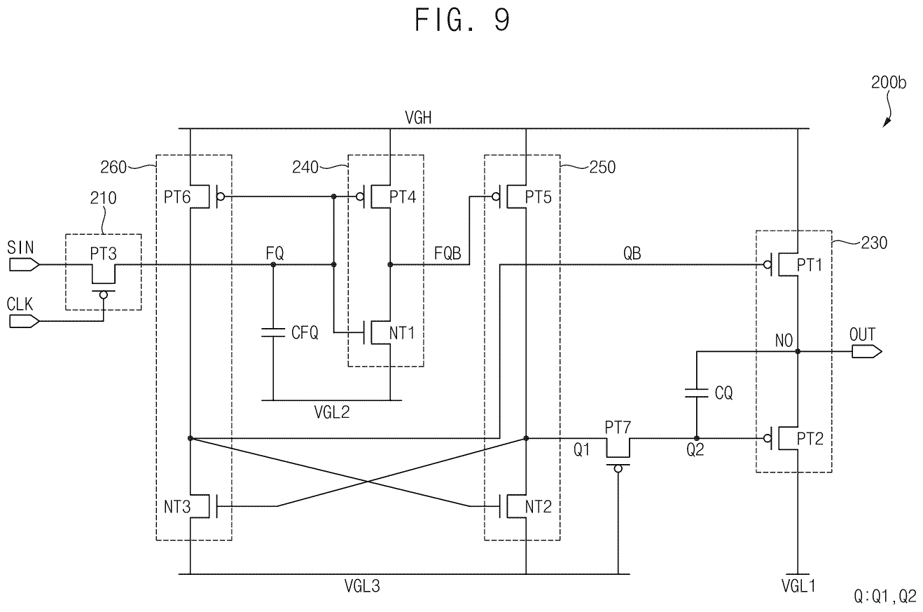

FIG. 9 is a circuit diagram illustrating an embodiment of a stage of a driver, and FIG. is a timing diagram for describing an embodiment of an operation of a stage of FIG. 9.

Referring to FIG. 9, a stage 200b of a driver in embodiments may include an input circuit 210, an output circuit 230, an inverter circuit 240, a first node control circuit 250, a second node control circuit 260, a first capacitor CFQ, a seventh PMOS transistor PT7 and a second capacitor CQ. The stage 200b of FIG. 9 may have substantially the same configuration and substantially the operation as a stage 200a of FIG. 5, except that the stage 200b may further include the seventh PMOS transistor PT7 and the second capacitor CQ.

The seventh PMOS transistor PT7 may be disposed at a first node Q to separate the first node Q into a fifth node Q1 and a sixth node Q2. Further, a gate of the seventh PMOS transistor PT7 may receive a third low gate voltage VGL3. Thus, since the seventh PMOS transistor PT7 receives the third low gate voltage VGL3 that is a low voltage for turning on the seventh PMOS transistor PT7, the seventh PMOS transistor PT7 may be also referred to as an always-on transistor (“AOT”). In an embodiment, the seventh PMOS transistor PT7 may include the gate connected to a third low gate voltage line that transfers the third low gate voltage VGL3, a first terminal connected to the fifth node Q1, and a second terminal connected to the sixth node Q2, for example.

The second capacitor CQ may be connected between an output node NO at which the output signal OUT is output, and the sixth node Q2. In an embodiment, the second capacitor CQ may include a first electrode connected to the output node NO, and a second electrode connected to the sixth node Q2, for example.

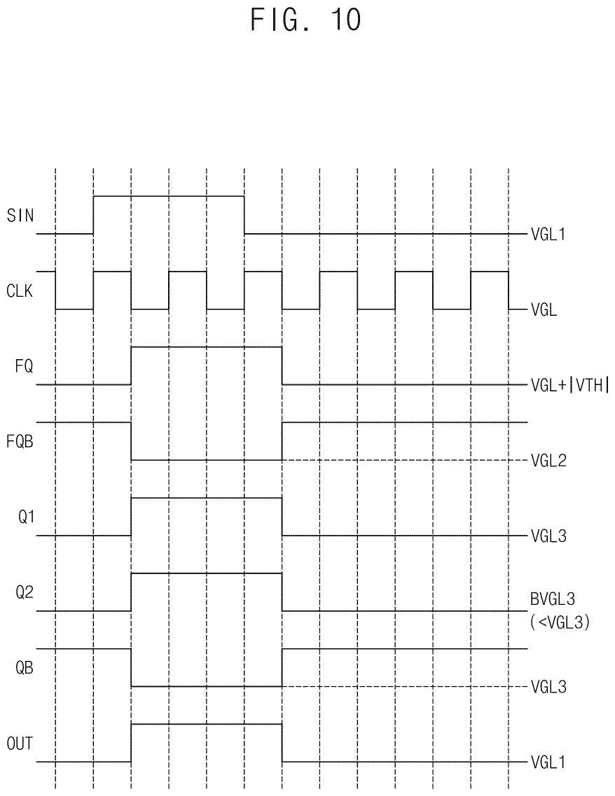

A bootstrapping operation that decreases a voltage of the sixth node Q2 may be performed by a second PMOS transistor PT2, the seventh PMOS transistor PT7 and the second capacitor CQ. In an embodiment, when the third low gate voltage VGL3 is provided to the fifth node Q1 through a second NMOS transistor NT2, the third low gate voltage VGL3 of the fifth node Q1 may be provided to the sixth node Q2 through the seventh PMOS transistor PT7, for example. The second PMOS transistor PT2 may be turned on in response to the third low gate voltage VGL3 of the sixth node Q2, and may provide a first low gate voltage VGL1 to the output node NO having a high gate voltage VGH. When a voltage of the output node NO connected to the first electrode of the second capacitor CQ decreases from the high gate voltage VGH to the first low gate voltage VGL1, the voltage of the sixth node Q2 connected to the second electrode of the second capacitor CQ may also decrease from the third low gate voltage VGL3 to a boosted low gate voltage BVGL3 as illustrated in FIG. 10. In a case where the voltage of the sixth node Q2 decreases to the boosted low gate voltage BVGL3 that is lower than the third low gate voltage VGL3 applied to the gate of the seventh PMOS transistor PT7, the seventh PMOS transistor PT7 may not transfer the boosted low gate voltage BVGL3 from the sixth node Q2 to the fifth node Q1. As described above, when the voltage of the sixth node Q2 is lowered to the boosted low gate voltage BVGL3 by the bootstrapping operation, a driving ability (or a turn-on degree) of the second PMOS transistor PT2 may be increased, and a falling speed of the output signal OUT from the high gate voltage VGH to the first low gate voltage VGL1 may be improved.

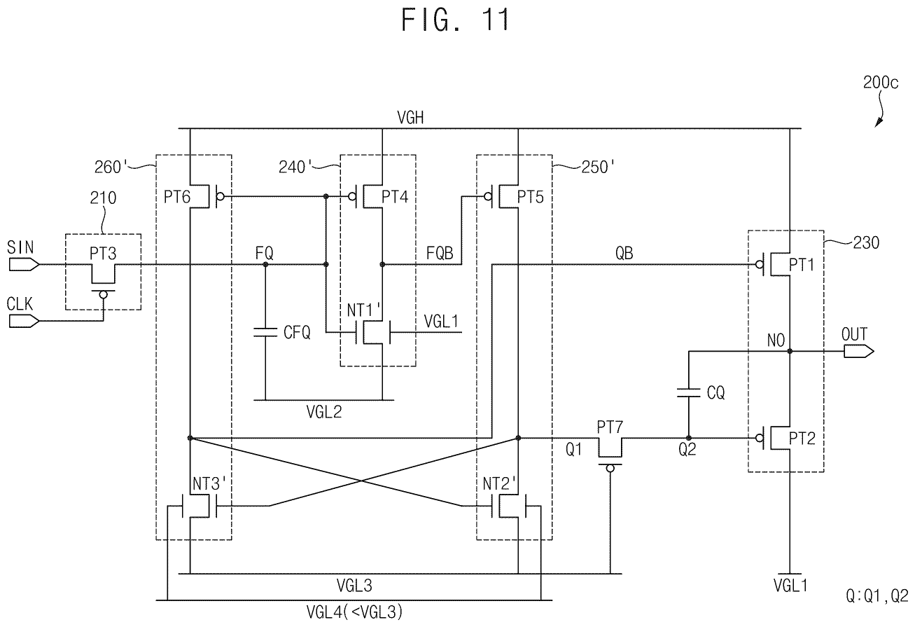

FIG. 11 is a circuit diagram illustrating an embodiment of a stage of a driver.

Referring to FIG. 11, a stage 200c of a driver in embodiments may include an input circuit 210, an output circuit 230, an inverter circuit 240′, a first node control circuit 250′, a second node control circuit 260′, a first capacitor CFQ, a seventh PMOS transistor PT7 and a second capacitor CQ. The stage 200c of FIG. 11 may have substantially the same configuration and substantially the operation as a stage 200b of FIG. 9, except that each the first, second and third NMOS transistors NT1′, NT2′, and NT3′ may include a bottom gate. Although FIG. 11 illustrates an embodiment in which each NMOS transistor includes a bottom gate compared with an embodiment of FIG. 9, those skilled in the art will readily appreciate that this feature illustrated in FIG. 11 may be combined with any embodiment. That is, additions or changes of the embodiment of FIG. 11 may be applied to embodiments different from the embodiment of FIG. 9. In an embodiment, in an embodiment of FIG. 5, each NMOS transistor may include a bottom gate, for example.

The first NMOS transistor NT1′ may include a gate connected to a third node FQ, a first terminal connected to a fourth node FQB, a second terminal connected to a second low gate voltage line that transfers a second low gate voltage VGL2, and a bottom gate connected to a first low gate voltage line that transfers a first low gate voltage VGL1. Since the bottom gate of the first NMOS transistor NT1′ receives the first low gate voltage VGL1 lower than the second low gate voltage VGL2 applied to the second terminal (e.g., a source) of the first NMOS transistor NT1′, a threshold voltage of the first NMOS transistor NT1′ may be increased (or shifted in a positive direction), and a leakage current through the first NMOS transistor NT1′ may be reduced.

The second NMOS transistor NT2′ may include a gate connected to a second node QB, a first terminal connected to a fifth node Q1, a second terminal connected to a third low gate voltage line that transfers a third low gate voltage VGL3, and a bottom gate connected to a fourth low gate voltage line that transfers a fourth low gate voltage VGL4, and the third NMOS transistor NT3′ may include a gate connected to the fifth node Q1, a first terminal connected to the second node QB, a second terminal connected to the third low gate voltage line, and a bottom gate connected to the fourth low gate voltage line. In some embodiments, the fourth low gate voltage VGL4 may be lower than the third low gate voltage VGL3. Thus, since the bottom gate of each of the second and third NMOS transistors NT2′ and NT3′ receives the fourth low gate voltage lower than the third low gate voltage VGL3 applied to its source, a threshold voltage of each of the second and third NMOS transistors NT2′ and NT3′ may be increased, and a leakage current through each of the second and third NMOS transistors NT2′ and NT3′ may be reduced.

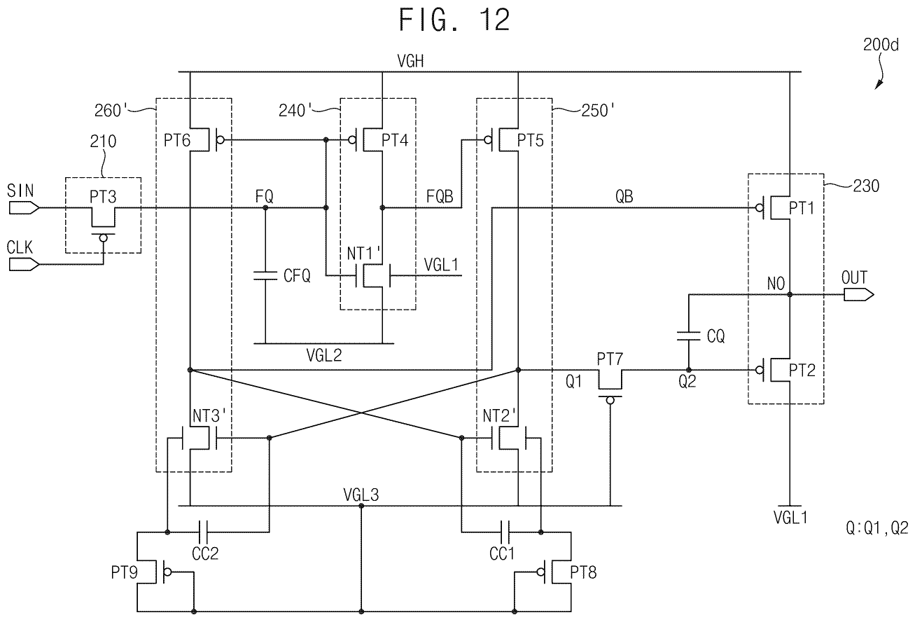

FIG. 12 is a circuit diagram illustrating an embodiment of a stage of a driver.

Referring to FIG. 12, a stage 200d of a driver in embodiments may include an input circuit 210, an output circuit 230, an inverter circuit 240′, a first node control circuit 250′, a second node control circuit 260′, a first capacitor CFQ, a seventh PMOS transistor PT7, a second capacitor CQ, a first coupling capacitor CC1, an eighth PMOS transistor PT8, a second coupling capacitor CC2 and a ninth PMOS transistor PT9. The stage 200d of FIG. 12 may have substantially the same configuration and substantially the same operation as a stage 200c of FIG. 11, except that the stage 200d may not receive a fourth low gate voltage VGL4, and may further include the first and second coupling capacitors CC1 and CC2 and the eighth and ninth PMOS transistors PT8 and PT9.

The first coupling capacitor CC1 may be connected between a second node QB and a bottom gate of a second NMOS transistor NT2′. The eighth PMOS transistor PT8 may include a gate connected to a third low gate voltage line that transfers a third low gate voltage VGL3, a first terminal connected to the bottom gate of the second NMOS transistor NT2′, and a second terminal connected to the third low gate voltage line. That is, the eighth PMOS transistor PT8 may have a diode connection structure in which a current flows only in a direction from the bottom gate of the second NMOS transistor NT2′ to the third low gate voltage line. Further, the second coupling capacitor CC2 may be connected between a fifth node Q1 (or a first node Q) and a bottom gate of a third NMOS transistor NT3′. The ninth PMOS transistor PT9 may include a gate connected to the third low gate voltage line, a first terminal connected to the bottom gate of the third NMOS transistor NT3′, and a second terminal connected to the third low gate voltage line. That is, the ninth PMOS transistor PT9 may have a diode connection structure in which a current flows only in a direction from the bottom gate of the third NMOS transistor NT3′ to the third low gate voltage line.

The first coupling capacitor CC1 and the eighth PMOS transistor PT8 may provide a voltage lower than the third low gate voltage VGL3 to the bottom gate of the second NMOS transistor NT2′ while the second NMOS transistor NT2′ is turned off. In an embodiment, when a voltage of the second node QB increases from the third low gate voltage VGL3 to a high gate voltage VGH, the second NMOS transistor NT2′ may be turned on, for example. Further, when the voltage of the second node QB increases, a voltage of the bottom gate of the second NMOS transistor NT2′ also may increase by the first coupling capacitor CC1. However, by the eighth PMOS transistor PT8 having the diode connection structure, the voltage of the bottom gate of the second NMOS transistor NT2′ may be decreased to the third low gate voltage VGL3 (or to a sum of the third low gate voltage VGL3 and a threshold voltage absolute value of the eighth PMOS transistor PT8). In an alternative embodiment, when the voltage of the second node QB decreases from the high gate voltage VGH to the third low gate voltage VGL3, the second NMOS transistor NT2′ may be turned off. Further, when the voltage of the second node QB decreases, the voltage of the bottom gate of the second NMOS transistor NT2′ also may decrease by the first coupling capacitor CC1. Thus, while the second NMOS transistor NT2′ is turned off, the voltage lower than the third low gate voltage VGL3 may be applied to the bottom gate of the second NMOS transistor NT2′, and a leakage current through the second NMOS transistor NT2′ may be reduced.

Further, the second coupling capacitor CC2 and the ninth PMOS transistor PT9 may provide a voltage lower than the third low gate voltage VGL3 to the bottom gate of the third NMOS transistor NT3′ while the third NMOS transistor NT3′ is turned off. In an embodiment, when a voltage of the fifth node Q1 increases from the third low gate voltage VGL3 to the high gate voltage VGH, the third NMOS transistor NT3′ may be turned on. Further, when the voltage of the fifth node Q1 increases, a voltage of the bottom gate of the third NMOS transistor NT3′ also may increase by the second coupling capacitor CC2, for example. However, by the ninth PMOS transistor PT9 having the diode connection structure, the voltage of the bottom gate of the third NMOS transistor NT3′ may be decreased to the third low gate voltage VGL3 (or to a sum of the third low gate voltage VGL3 and a threshold voltage absolute value of the ninth PMOS transistor PT9). In an alternative embodiment, when the voltage of the fifth node Q1 decreases from the high gate voltage VGH to the third low gate voltage VGL3, the third NMOS transistor NT3′ may be turned off. Further, when the voltage of the fifth node Q1 decreases, the voltage of the bottom gate of the third NMOS transistor NT3′ also may decrease by the second coupling capacitor CC2. Thus, while the third NMOS transistor NT3′ is turned off, the voltage lower than the third low gate voltage VGL3 may be applied to the bottom gate of the third NMOS transistor NT3′, and a leakage current through the third NMOS transistor NT3′ may be reduced.

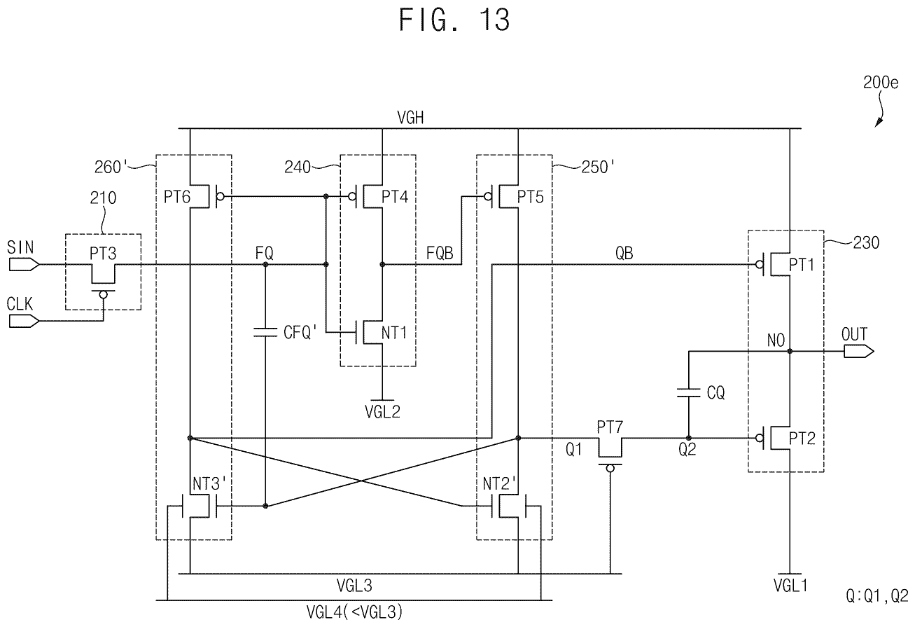

FIG. 13 is a circuit diagram illustrating an embodiment of a stage of a driver.

Referring to FIG. 13, a stage 200e of a driver in embodiments may include an input circuit 210, an output circuit 230, an inverter circuit 240, a first node control circuit 250′, a second node control circuit 260′, a first capacitor CFQ′, a seventh PMOS transistor PT7 and a second capacitor CQ. The stage 200e of FIG. 13 may have substantially the same configuration and substantially the same operation as a stage 200c of FIG. 11, except that a first NMOS transistor NT1 may not have a bottom gate, and the first capacitor CFQ′ may be connected to a fifth node Q1 (or a first node Q) instead of a second low gate voltage line that transfers the second low gate voltage VGL2.

The first capacitor CFQ′ may be connected between a third node FQ and the fifth node Q1 (or the first node Q). When the third node FQ becomes a low voltage, the fifth node Q1 (or the first node Q) also may decrease from a high gate voltage VGH to a third low gate voltage VGL3. Further, by first capacitor CFQ′, the low voltage of the third node FQ may be further decreased. Accordingly, the decreased low voltage of the third node FQ may be applied to a gate of the first NMOS transistor NT1, and thus a leakage current through the first NMOS transistor NT1 may be reduced.

Although FIG. 13 illustrates an embodiment in which the first capacitor CFQ′ is connected to the fifth node Q1 (or the first node Q) modified from an embodiment of FIG. 11, those skilled in the art will readily appreciate that additions or changes of the embodiment of FIG. 13 may be applied to embodiments different from the embodiment of FIG. 11.

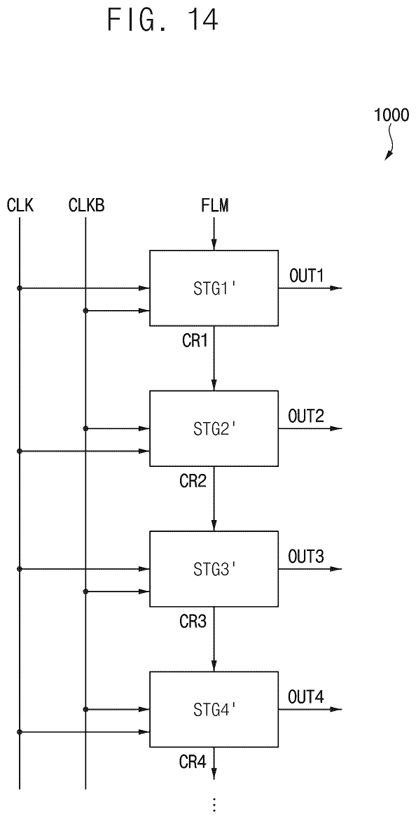

FIG. 14 is a block diagram illustrating an embodiment of a driver.

Referring to FIG. 14, a driver 1000 in embodiments may include a plurality of stages STG1′, STG2′, STG3′, STG4′, etc.

In the driver 1000 of FIG. 14, unlike a driver 100 of FIG. 1 in which each stage receives an output signal of a previous stage as an input signal, each stage (e.g., a second stage STG2′) may receive a carry signal (e.g., a first carry signal CR1) of a previous stage (e.g., a first stage STG1′) as an input signal. In an embodiment, the second stage STG2′ may receive the first carry signal CR1 of the first stage STG1′ as an input signal, a third stage STG3′ may receive a second carry signal CR2 of the second stage STG2′ as an input signal, and a fourth stage STG4′ may receive a third carry signal CR3 of the third stage STG3′ as an input signal, for example.

Further, in some embodiment, each odd-numbered stage STG1′, STG3′, etc., may start outputting a carry signal CR1, CR3, . . . and an output signal OUT1, OUT3, etc., when a clock signal CLK has a relatively low level and an inverted clock signal CLKB has a relatively high level, and each even-numbered stage STG2′, STG4′, etc., may start outputting a carry signal CR2, CR4, etc., and an output signal OUT2, OUT4, etc., when the clock signal CLK has a relatively high level and the inverted clock signal CLKB has a relatively low level.

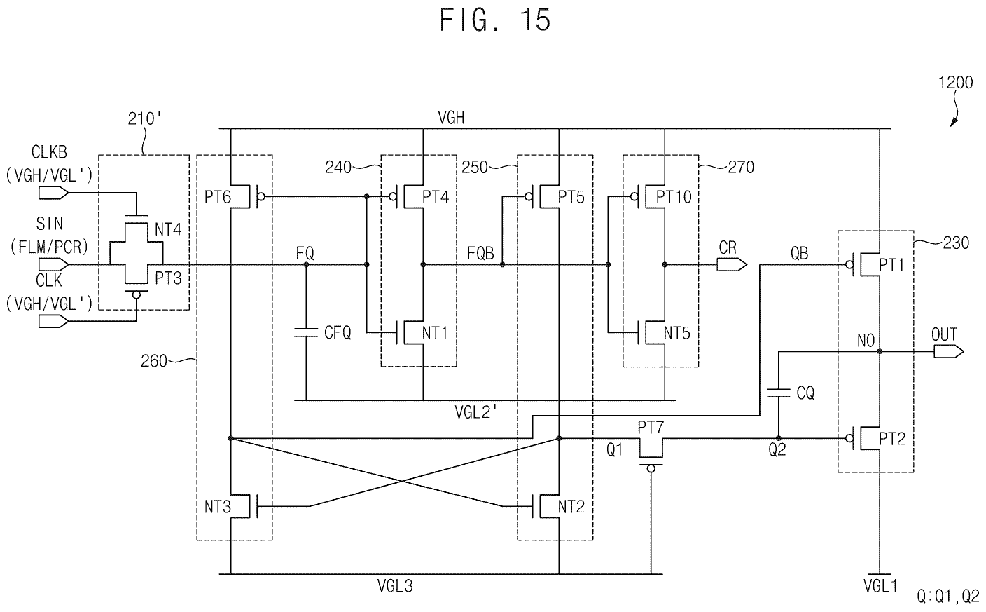

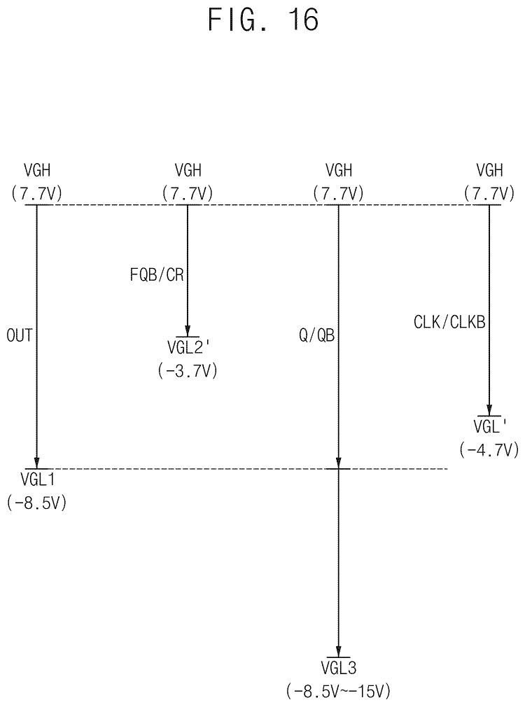

FIG. 15 is a circuit diagram illustrating an embodiment of a stage of a driver, and FIG. 16 is a diagram for describing an embodiment of voltages for a driver.

Referring to FIG. 15, a stage 1200 of a driver in embodiments may include an input circuit 210′, an output circuit 230, an inverter circuit 240, a first node control circuit 250, a second node control circuit 260, a first capacitor CFQ, a seventh PMOS transistor PT7, a second capacitor CQ and a carry circuit 270. The stage 1200 of FIG. 15 may have substantially the same configuration and substantially the same operation as the stage 200b of FIG. 9, except that the stage 1200 may receive a carry signal PCR of a previous stage instead of an output signal of the previous stage as an input signal SIN, the input circuit 210′ may further include a fourth NMOS transistor NT4, and the stage 1200 may further include the carry circuit 270. Although FIG. 15 illustrates an embodiment that further includes the fourth NMOS transistor NT4 and the carry circuit 270 compared with the embodiment of FIG. 9, any one of the above-described embodiments may further include the fourth NMOS transistor NT4 and the carry circuit 270.

The input circuit 210′ may include not only a third PMOS transistor PT3 that transfers the input signal SIN to a third node FQ in response to a clock signal CLK, but also the fourth NMOS transistor NT4 that transfers the input signal SIN in response to an inverted clock signal CLKB. Thus, when the input signal SIN has a second low gate voltage VGL2′ and the inverted clock signal CLKB has a high gate voltage VGH, the fourth NMOS transistor NT4 may be turned on, and may transfer the second low gate voltage VGL2′ of the input signal SIN to the third node FQ. That is, when the input signal SIN has the second low gate voltage VGL2′, the fourth NMOS transistor NT4 may transfer the input signal SIN to the third node FQ, and thus a voltage of the third node FQ may become substantially equal to the second low gate voltage VGL2′ of the input signal SIN. In some embodiments, to prevent a leakage current through the fourth NMOS transistor NT4 while the inverted clock signal CLKB has a low gate voltage VGL′, the low gate voltage VGL′ of the clock signal CLK and the inverted clock signal CLKB may be lower than the second low gate voltage VGL2′ of the input signal SIN and a carry signal CR. That is, the low gate voltage VGL′ of the clock signal CLK and the inverted clock signal CLKB may be higher than a first low gate voltage VGL1 of the output signal OUT and lower than the second low gate voltage VGL2′.

The carry circuit 270 may include a tenth PMOS transistor PT10 that outputs the high gate voltage VGH as the carry signal CR in response to a voltage of a fourth node FQB, and a fifth NMOS transistor NT5 that outputs the second low gate voltage VGL2′ as the carry signal CR in response to the voltage of the fourth node FQB. In an embodiment, the tenth PMOS transistor PT10 may include a gate connected to the fourth node FQB, a first terminal connected to a high gate voltage line that transfers the high gate voltage VGH, and a second terminal connected to a carry node at which the carry signal CR is output, and the fifth NMOS transistor NT5 may include a gate connected to the fourth node FQB, a first terminal connected to the carry node, and a second terminal connected to a second low gate voltage line that transfers the second low gate voltage VGL2′, for example. In some embodiments, the second low gate voltage VGL2′ may be higher than the first low gate voltage VGL1 of the output signal OUT.

Unlike stages 200a, 200b, 200c, 200d and 200e of FIGS. 5, 9, 11, 12 and 13, since the input circuit 210′ of the stage 1200 further includes the fourth NMOS transistor NT4, and receives the carry signal PCR of the previous stage as the input signal SIN instead of an output signal of the previous stage, the second low gate voltage VGL2′ of the input signal SIN and the carry signal CR may be set higher than the first low gate voltage VGL1 of the output signal OUT, and the low gate voltage VGL′ of the clock signal CLK and the inverted clock signal CLKB also may be set higher than a low gate voltage VGL in the stages 200a, 200b, 200c, 200d and 200e of FIGS. 5, 9, 11, 12 and 13. In an embodiment, as illustrated in FIG. 16, the second low gate voltage VGL2′ may be, but is not limited to, about −3.7V, and the low gate voltage VGL′ may be, but is not limited to, about −4.7V, for example. Accordingly, a swing width of the clock signal CLK and the inverted clock signal CLKB may be further reduced compared with a swing width of the output signal OUT, and thus power consumption of the driver including the stage 1200 may be further reduced.

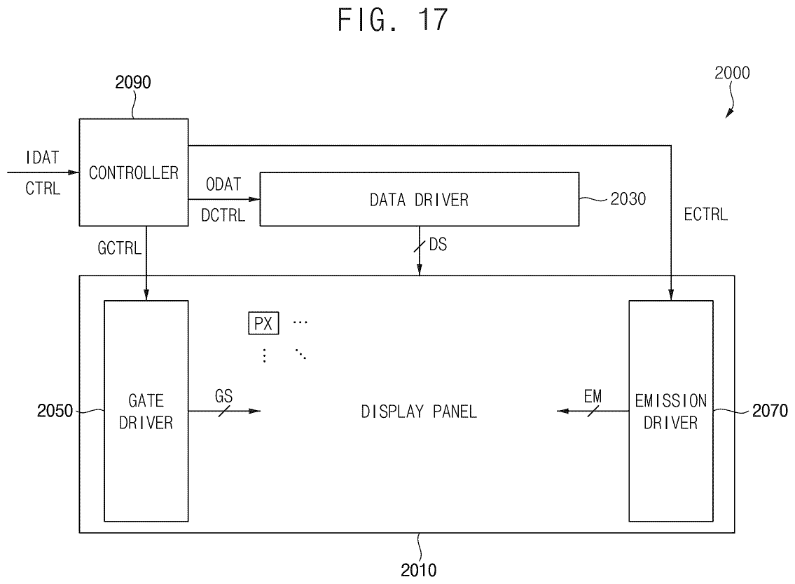

FIG. 17 is a block diagram illustrating an embodiment of a display device.

Referring to FIG. 17, a display device 2000 in embodiments may include a display panel 2010 that includes a plurality of pixels PX, a data driver 2030 that provides data signals DS to the plurality of pixels PX, a gate driver 2050 that provides gate signals GS to the plurality of pixels PX, an emission driver 2070 that provides emission signals EM to the plurality of pixels PX, and a controller 2090 that controls the data driver 2030, the gate driver 2050 and the emission driver 2070.

The display panel 2010 may include data lines, gate lines, emission lines, and the plurality of pixels PX connected thereto. In some embodiments, each pixel PX may include a light-emitting element, and the display panel 2010 may be a light-emitting display panel. In some embodiments, the light-emitting element may be an organic light-emitting diode (“OLED”). In other embodiments, the light-emitting element may be a nano light-emitting diode (“NED”), a quantum dot (“QD”) light-emitting diode, a micro light-emitting diode, an inorganic light-emitting diode, or any other suitable light-emitting element. In other embodiments, the display panel 2010 may be a liquid crystal display (“LCD”) panel, or any other suitable display panel.

The data driver 2030 may generate the data signals DS based on a data control signal DCTRL and output image data ODAT received from the controller 2090, and may provide the data signals DS to the plurality of pixels PX through the data lines. In some embodiments, the data control signal DCTRL may include, but is not limited to, an output data enable signal, a horizontal start signal, and a load signal. In some embodiments, the data driver 2030 and the controller 2090 may be implemented as a single integrated circuit, and the single integrated circuit may be also referred to as a timing controller embedded data driver (“TED”) integrated circuit. In other embodiments, the data driver 2030 and the controller 2090 may be implemented as separate integrated circuits.

The gate driver 2050 may generate the gate signals GS based on a gate control signals GCTRL received from the controller 2090, and may sequentially provide the gate signals GS to the plurality of pixels PX through the gate lines on a row-by-row basis. In some embodiments, the gate control signal GCTRL may include, but is not limited to, a gate start signal and a gate clock signal. In some embodiments, the gate driver 2050 may be a driver 100 of FIG. 1 including a stage 200a of FIG. 5, a stage 200b of FIG. 9, a stage 200c of FIG. 11, a stage 200d of FIG. 12 or a stage 200e of FIG. 13, or may be a driver 1000 of FIG. 14 including a stage 1200 of FIG. 15. Further, in some embodiments, as illustrated in FIG. 17, the gate driver 2050 may be integrated or formed in the display panel 2010. In other embodiments, the gate driver 2050 may be implemented as one or more integrated circuits.

The emission driver 2070 may generate the emission signals EM based on an emission control signal ECTRL received from the controller 2090, and may sequentially provide the emission signals EM to the plurality of pixels PX through the emission lines on a row-by-row basis. In some embodiments, the emission control signal ECTRL may include, but is not limited to, an emission start signal and an emission clock signal. In some embodiments, the emission driver 2070 may be a driver 100 of FIG. 1 including a stage 200a of FIG. 5, a stage 200b of FIG. 9, a stage 200c of FIG. 11, a stage 200d of FIG. 12 or a stage 200e of FIG. 13, or may be a driver 1000 of FIG. 14 including a stage 1200 of FIG. 15. Further, in some embodiments, as illustrated in FIG. 17, the emission driver 2070 may be integrated or formed in the display panel 2010. In other embodiments, the emission driver 2070 may be implemented as one or more integrated circuits.

The controller 2090 (e.g., a timing controller (“TCON”)) may receive input image data IDAT and a control signal CTRL from an external host processor (e.g., a graphics processing unit (“GPU”), an application processor (“AP”) or a graphics card). In some embodiments, the input image data IDAT may be red, green and blue (“RGB”) image data including red image data, green image data and blue image data. In some embodiments, the control signal CTRL may include, but is not limited to, a vertical synchronization signal, a horizontal synchronization signal, an input data enable signal, a master clock signal, etc. The controller 2090 may generate the output image data ODAT, the data control signal DCTRL, the gate control signal GCTRL and the emission control signal ECTRL based on the input image data IDAT and the control signal CTRL. The controller 2090 may control an operation of the data driver 2030 by providing the output image data ODAT and the data control signal DCTRL to the data driver 2030, may control an operation of the gate driver 2050 by providing the gate control signal GCTRL to the gate driver 2050, and may control an operation of the emission driver 2070 by providing the emission control signal ECTRL to the emission driver 2070.

In the display device 2000 in embodiments, at least one driver of the gate driver 2050 and the emission driver 2070 may be implemented as the driver 100 of FIG. 1 or the driver 1000 of FIG. 14. At least one stage of the driver may include an input circuit, an inverter circuit, a first node control circuit, a second node control circuit and an output circuit, and at least one of the inverter circuit, the first node control circuit and the second node control circuit may include different types of transistors. Further, a swing width of a clock signal applied to the input circuit may be smaller than a swing width of an output signal output from the output circuit. Accordingly, the driver may stably operate while reducing power consumption.

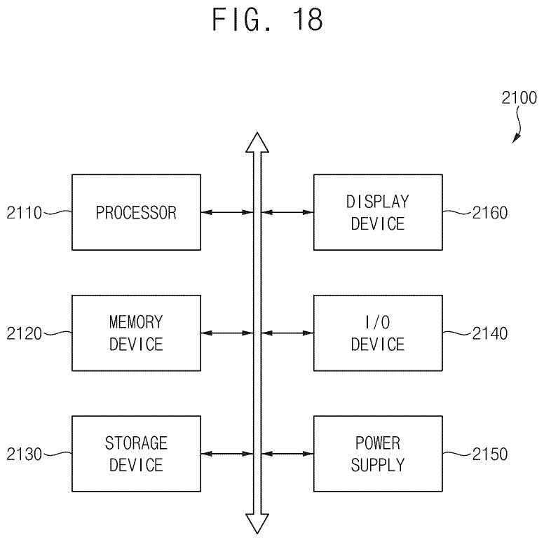

FIG. 18 is a block diagram illustrating an embodiment of an electronic device including a display device.

Referring to FIG. 18, an electronic device 2100 may include a processor 2110, a memory device 2120, a storage device 2130, an input/output (“I/O”) device 2140, a power supply 2150, and a display device 2160. The electronic device 2100 may further include a plurality of ports for communicating a video card, a sound card, a memory card, a universal serial bus (“USB”) device, other electric devices, etc.

The processor 2110 may perform various computing functions or tasks. The processor 2110 may be an application processor (“AP”), a micro-processor, a central processing unit (“CPU”), etc. The processor 2110 may be connected to other components via an address bus, a control bus, a data bus, etc. Further, in some embodiments, the processor 2110 may be further connected to an extended bus such as a peripheral component interconnection (“PCI”) bus.

The memory device 2120 may store data for operations of the electronic device 2100. In an embodiment, the memory device 2120 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, etc., and/or at least one volatile memory device such as a dynamic random access memory (“DRAM”) device, a static random access memory (“SRAM”) device, a mobile dynamic random access memory (“mobile DRAM”) device, etc., for example.

The storage device 2130 may be a solid state drive (“SSD”) device, a hard disk drive (“HDD”) device, a compact disc read-only memory (“CD-ROM”) device, etc. The I/O device 2140 may be an input device such as a keyboard, a keypad, a mouse, a touch screen, etc., and an output device such as a printer, a speaker, etc. The power supply 2150 may supply power for operations of the electronic device 2100. The display device 2160 may be connected to other components through the buses or other communication links.

In the display device 2160, at least one stage may include an input circuit, an inverter circuit, a first node control circuit, a second node control circuit and an output circuit, and at least one of the inverter circuit, the first node control circuit and the second node control circuit may include different types of transistors. Further, a swing width of a clock signal applied to the input circuit may be smaller than a swing width of an output signal output from the output circuit. Accordingly, the driver may stably operate while reducing power consumption.

The inventive concepts may be applied to any display device 2160 and any electronic device 2100 including the display device 2160. In an embodiment, the inventive concepts may be applied to a smart phone, a wearable electronic device, a tablet computer, a mobile phone, a television (“TV”) (e.g., a digital TV, a three dimensional (“3D”) TV, etc.), a personal computer (“PC”), a home appliance, a laptop computer, a personal digital assistant (“PDA”), a portable multimedia player (“PMP”), a digital camera, a music player, a portable game console, a navigation device, etc., for example.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. Therefore, it is to be understood that the foregoing is illustrative of various embodiments and is not to be construed as limited to the illustrative embodiments disclosed, and that modifications to the disclosed embodiments, as well as other embodiments, are intended to be included within the scope of the appended claims.

What is claimed is:

1. A driver including:
a plurality of stages, at least one stage of the plurality of stages comprising:
an input circuit which transfers an input signal to a third node in response to a clock signal;
an inverter circuit which inverts a voltage of the third node and generate a voltage of a fourth node;
a first node control circuit which controls a voltage of a first node based on the voltage of the fourth node and a voltage of a second node;
a second node control circuit which controls the voltage of the second node based on the voltage of the third node and the voltage of the first node; and
an output circuit which generates an output signal based on the voltage of the first node and the voltage of the second node,
wherein at least one of the inverter circuit, the first node control circuit and the second node control circuit includes different types of transistors.

2. The driver of claim 1, wherein the output signal has a first low gate voltage as a low voltage,
the fourth node has a second low gate voltage as a low voltage,
the first node has a third low gate voltage as a low voltage, and
at least two of the first, second and third low gate voltages have different voltage levels from each other.

3. The driver of claim 2, wherein the second low gate voltage is higher than the first low gate voltage, and
the third low gate voltage is lower than or equal to the first low gate voltage.

4. The driver of claim 2, wherein a low gate voltage of the clock signal is different from the first, second and third low gate voltages.

5. The driver of claim 1, wherein the input signal, the clock signal, the output signal, the first node, the second node, the third node and the fourth node have a same high gate voltage as a high voltage.

6. The driver of claim 1, wherein the output circuit includes:
a first p-type metal-oxide-semiconductor transistor which outputs a high gate voltage as the output signal in response to the voltage of the second node; and
a second p-type metal-oxide-semiconductor transistor which outputs a first low gate voltage as the output signal in response to the voltage of the first node.

7. The driver of claim 1, wherein the input circuit includes:
a third p-type metal-oxide-semiconductor transistor which transfers the input signal to the third node in response to the clock signal.

8. The driver of claim 7, wherein the input circuit further includes:
a fourth n-type metal-oxide-semiconductor transistor which transfers the input signal to the third node in response to an inverted clock signal.

9. The driver of claim 1, wherein the inverter circuit includes:
a fourth p-type metal-oxide-semiconductor transistor which provides a high gate voltage to the fourth node in response to the voltage of the third node; and
a first n-type metal-oxide-semiconductor transistor which provides a second low gate voltage to the fourth node in response to the voltage of the third node.

10. The driver of claim 1, wherein the first node control circuit includes:
a fifth p-type metal-oxide-semiconductor transistor which provides a high gate voltage to the first node in response to the voltage of the fourth node; and
a second n-type metal-oxide-semiconductor transistor which provides a third low gate voltage to the first node in response to the voltage of the second node.

11. The driver of claim 1, wherein the second node control circuit includes:
a sixth p-type metal-oxide-semiconductor transistor which provides a high gate voltage to the second node in response to the voltage of the third node; and
a third n-type metal-oxide-semiconductor transistor which provides a third low gate voltage to the second node in response to the voltage of the first node.

12. The driver of claim 1, wherein the at least one stage further comprises:
a capacitor connected between the third node and a second low gate voltage line.

13. The driver of claim 1, wherein the at least one stage further comprises:
a capacitor connected between the third node and the first node.

14. The driver of claim 1, wherein the at least one stage further comprises:
a seventh p-type metal-oxide-semiconductor transistor including a gate which receives a third low gate voltage, and disposed at the first node to separate the first node into a fifth node and a sixth node; and
a capacitor connected between an output node at which the output signal is output and the sixth node.

15. The driver of claim 1, wherein the first node control circuit includes a second n-type metal-oxide-semiconductor transistor which provides a third low gate voltage to the first node,
wherein the second node control circuit includes a third n-type metal-oxide-semiconductor transistor which provides the third low gate voltage to the second node, and
wherein each of the second and third n-type metal-oxide-semiconductor transistors includes a bottom gate which receives a fourth low gate voltage lower than the third low gate voltage.

16. The driver of claim 1, wherein the first node control circuit includes a second n-type metal-oxide-semiconductor transistor which provides a third low gate voltage to the first node, and the second n-type metal-oxide-semiconductor transistor includes a first bottom gate,
wherein the second node control circuit includes a third n-type metal-oxide-semiconductor transistor which provides the third low gate voltage to the second node, and the third n-type metal-oxide-semiconductor transistor includes a second bottom gate, and
wherein the at least one stage further comprises:
a first coupling capacitor connected between the second node and the first bottom gate;
an eighth p-type metal-oxide-semiconductor transistor including a gate connected to a third low gate voltage line which transfers the third low gate voltage, a first terminal connected to the first bottom gate, and a second terminal connected to the third low gate voltage line;
a second coupling capacitor connected between the first node and the second bottom gate; and
a ninth p-type metal-oxide-semiconductor transistor including a gate connected to the third low gate voltage line, a first terminal connected to the second bottom gate, and a second terminal connected to the third low gate voltage line.

17. The driver of claim 1, wherein the at least one stage further comprises:
a carry circuit which generates a carry signal based on the voltage of the fourth node, and
wherein the carry circuit includes:
a tenth p-type metal-oxide-semiconductor transistor which outputs a high gate voltage as the carry signal in response to the voltage of the fourth node; and
a fifth n-type metal-oxide-semiconductor transistor which outputs a second low gate voltage as the carry signal in response to the voltage of the fourth node.

18. The driver of claim 17, wherein the second low gate voltage is higher than a first low gate voltage which is a low voltage of the output signal, and
wherein a low gate voltage of the clock signal is higher than the first low gate voltage and lower than the second low gate voltage.

19. A driver including a plurality of stages, at least one stage of the plurality of stages comprising:
a first p-type metal-oxide-semiconductor transistor including a gate connected to a second node, a first terminal connected to a high gate voltage line, and a second terminal connected to an output node;
a second p-type metal-oxide-semiconductor transistor including a gate connected to a first node, a first terminal connected to the output node, and a second terminal connected to a first low gate voltage line;
a third p-type metal-oxide-semiconductor transistor including a gate that receives a clock signal, a first terminal that receives an input signal, and a second terminal connected to a third node;
a fourth p-type metal-oxide-semiconductor transistor including a gate connected to the third node, a first terminal connected to the high gate voltage line, and a second terminal connected to a fourth node;
a first n-type metal-oxide-semiconductor transistor including a gate connected to the third node, a first terminal connected to the fourth node, and a second terminal connected to a second low gate voltage line;
a fifth p-type metal-oxide-semiconductor transistor including a gate connected to the fourth node, a first terminal connected to the high gate voltage line, and a second terminal connected to the first node;
a second n-type metal-oxide-semiconductor transistor including a gate connected to the second node, a first terminal connected to the first node, and a second terminal connected to a third low gate voltage line;
a sixth p-type metal-oxide-semiconductor transistor including a gate connected to the third node, a first terminal connected to the high gate voltage line, and a second terminal connected to the second node;
a third n-type metal-oxide-semiconductor transistor including a gate connected to the first node, a first terminal connected to the second node, and a second terminal connected to the third low gate voltage line; and
a capacitor connected between the third node and the second low gate voltage line.

20. A display device comprising:
a display panel including a plurality of pixels;
a data driver which provides data signals to the plurality of pixels;
a gate driver which provides gate signals to the plurality of pixels;
an emission driver which provides emission signals to the plurality of pixels; and
a controller which controls the data driver, the gate driver and the emission driver, at least one of the gate driver and the emission driver including:
a plurality of stages, at least one stage of the plurality of stages comprising:
an input circuit which transfers an input signal to a third node in response to a clock signal;
an inverter circuit which inverts a voltage of the third node and generates a voltage of a fourth node;
a first node control circuit which controls a voltage of a first node based on the voltage of the fourth node and a voltage of a second node;
a second node control circuit which controls the voltage of the second node based on the voltage of the third node and the voltage of the first node; and
an output circuit which generates an output signal based on the voltage of the first node and the voltage of the second node,
wherein at least one of the inverter circuit, the first node control circuit and the second node control circuit includes different types of transistors.
